(19) United States
(12) Patent Application Publication
(10) Pub. No.: US 2009/0078232 A1
(43) Pub. Date: Mar. 26, 2009

(54) Emulsion system for diesel fuel and water for an internal combustion engine

(76) Inventor: Guenther Kramb, Simmern (DE)

Correspondence Address: DONALD G. FLAYNIK JR.;CHERSKOV & FLAYNIK, 25208 West Reed St., P.O. Box 114, Channahon, IL, 60410, US

(21) Appl. No.: 12/284,422

(22) Filed: Sep. 22, 2008

Related U.S. Application Data
(60) Provisional application No. 60/994,873, filed on Sep. 21, 2007.

(51) Int. Cl. F02B 47/02; F02D 19/12; B01F 3/08; C10L 10/00

(52) U.S. Cl. 123/25 R; 123/25 Q; 123/25 J; 366/165.4

(57) ABSTRACT

An emulsion system 10 for diesel fuel and water for a diesel internal combustion engine includes a ratio member 12 for combining predetermined quantities of diesel fuel and water, and an emulsifier 14 for emulsifying diesel fuel and water such that the resulting combination is ultimately urged through fuel injectors 16, then “exploded” in the combustion chambers of the diesel internal combustion engine.

This application is based on U.S. Provisional Application No. 60/994,873 filed on Sep. 21, 2007.

### BACKGROUND OF THE INVENTION

1. Field of the Invention

This invention relates to emulsifying water and diesel fuel for injection into a diesel internal combustion engine, and more particularly, to increasing fuel efficiency and reducing particulate and Nox and CO2 gas emissions relative to diesel engines.

2. Background of the Prior Art

Injecting water into diesel fuel for ultimately powering a diesel internal combustion engine has been attempted in many ways in the prior art with problematic results. Prior methods of combining water and diesel fuel include injecting water directly into the combustion chamber or intake manifold of the diesel engine, and mixing water and diesel fuel before injection into the combustion chamber. The problem with injecting water directly into the combustion chamber or manifold is that corrosion forms and cavitation of the water frequently occurs. The problem with prior art methods of mixing water and diesel fuel before injection into the combustion chamber is that the systems are to complicated to be retrofitted into a moving vehicle.

Further, prior art methods of emulsifying water and diesel fuel are inadequate when attempting to vary the water-diesel fuel ratio relative to varying engine loads or other engine operating parameters that may vary over time. Also, prior art methods of emulsifying water and diesel fuel fail to keep separated diesel fuel and water before the mixing stage and fail to reduce the size of the emulsified water and diesel fuel droplets ultimately formed inside the combustion chamber, thereby reducing fuel efficiency and increasing particulate discharge in the exhaust gas.

A need exists for an emulsion system that provides separate sources of water and diesel fuel before mixing the two together; that is capable of mixing water and diesel fuel at a constant ratio irrespective of the volume required by an internal combustion engine to satisfy the load placed thereupon; that is capable of mixing water and diesel fuel at varying ratios depending upon the load and operating conditions imposed upon the engine; that is simple in design to promote installation into a moving vehicle; that emulsifies water and diesel fuel such that the resultant fuel retains its explosive characteristics for a time period sufficient to insure that the fuel explodes inside the combustion chamber with sufficient force to satisfy required engine output power; and that provides a water and diesel fuel emulsion that provides relatively small droplets when injected into a diesel engine combustion chamber that promotes an enhanced air-fuel mixture that ultimately is compressed and ignited, thereby providing required engine output power, increased fuel efficiency and reduced particle and gas pollutants discharged to atmosphere via the engine exhaust.

### SUMMARY OF THE INVENTION

It is an object of the present invention to overcome may of the disadvantages associated with prior art emulsifying systems for emulsifying diesel fuel and water for an internal combustion engine.

A principal object of the present invention is to provide an emulsifying system that combines or mixes diesel fuel and water. A feature of the emulsifying system is a ratio member. An advantage of the emulsifying system is that the ratio member provides a mixture of fuel oil and water in volumes corresponding to required engine power output based on load demands placed upon the engine. Another advantage of the emulsifying system is that two independent containers are used to hold water and diesel fuel, and two separate supply systems are used to provide water and diesel fuel to the ratio member, thereby maintaining complete separation between water and diesel fuel until being combined in the ratio member. Still another advantage of the emulsifying system is that the ratio member is capable of adding water to diesel fuel in a volume range between zero and twenty-five percent (0%-25%).

Another object of the present invention is to provide an emulsifying system capable of emulsifying water and diesel fuel for internal combustion engines with varying engine loads. A feature of the emulsifying system is an emulsifier that swirls or combines water and diesel fuel at speeds approaching super sonic. An advantage of the system is that the water and diesel fuel remain as an emulsion for a period of time (at least two minutes) to allow the emulsion to circulate through an emulsion loop such that the emulsion ultimately flows through fuel injectors and into a cylinder where the emulsion mixes with air, then is compressed until exploding to provide power to the internal combustion engine. Another advantage of the system is that the emulsifier is capable of emulsifying water and diesel fuel that vary in volume ratios between zero and twenty-five percent (0%-25%). Other advantages of the system is that the emulsion fuel increases the fuel efficiency of the engine, decreases particulate and gas emissions (in particular NOx and CO2) from the engine, and the system is relatively easy to retrofit to a moving vehicle that is driven by an internal combustion engine.

Briefly, the invention provides an emulsion system for diesel fuel and water for an internal combustion engine comprising means for combining diesel-fuel and water quantities based upon required power output from an internal combustion engine; and means for emulsifying diesel fuel and water, whereby diesel fuel and water are combined to provide a fuel for an internal combustion engine that reduces particulate emission from the internal combustion engine and increases the efficiency of the internal combustion engine, while providing sufficient power output from the internal combustion engine to satisfy load demands placed upon the engine.

Further, the invention provides a method for reducing particulate emissions from an internal combustion engine, said method comprising the steps of combining diesel fuel and water at predetermined quantities corresponding to required power output from an internal combustion engine; and emulsifying said combined diesel fuel and water quantities, whereby particulate emission from the internal combustion engine is reduced, while providing required power output and increasing fuel efficiency.

Also, the invention provides a device for increasing fuel efficiency in an internal combustion engine comprising a ratio member for combining predetermined quantities of diesel fuel and water; an emulsifier for emulsifying diesel fuel and water such that the resulting combination is ultimately exploded in an internal combustion engine; and means for providing only diesel fuel to the internal combustion engine when the internal combustion engine is in an idle condition.

### BRIEF DESCRIPTION OF THE DRAWINGS

These and other objects, advantages and novel features of the present invention, as well as details of an illustrative embodiment thereof, will be more fully understood from the following detailed description and attached drawings, wherein:

FIG. 1 is a block diagram of an emulsion system for diesel fuel and water for an internal combustion engine in accordance with the present invention.

### DESCRIPTION OF THE PREFERRED EMBODIMENT

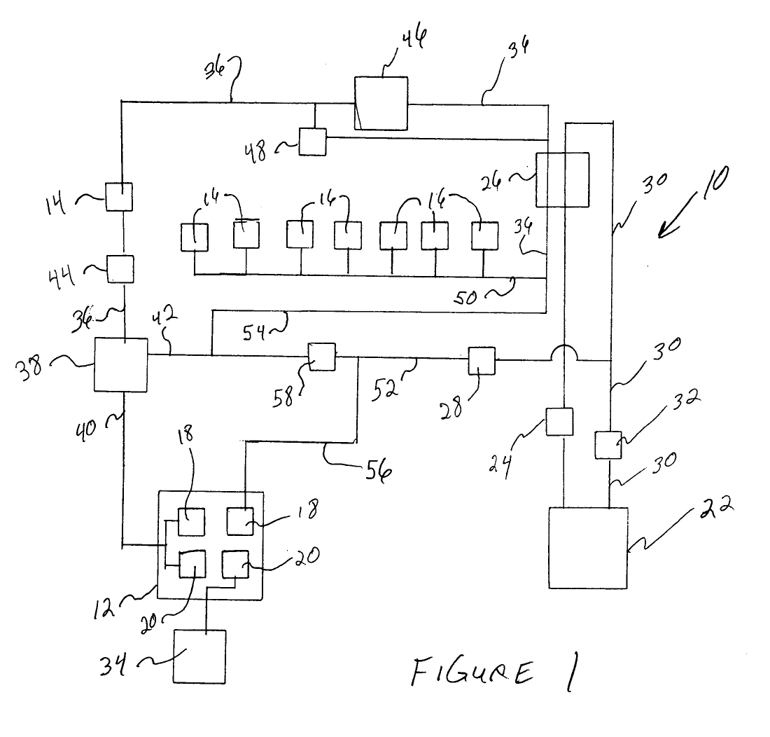

Referring now to FIG. 1, an emulsion system for diesel fuel and water for an internal combustion engine is denoted by numeral 10. The emulsion system 10 includes a ratio member 12 for combining predetermined quantities of diesel fuel and water, and an emulsifier 14 for emulsifying diesel fuel and water such that the resulting combination is ultimately urged through fuel injectors 16, then “exploded” in the cylinders of an internal combustion engine (not depicted).

A myriad of ratio equipment is available “off the shelf” from a relatively large number of manufactures. The ratio member 12 utilized for the present invention is well known to those of ordinary skill in the art, and is manufactured by and may be purchased from the inventors at Koblenzer Str. 72, D-55467 Simmern, P.O. Box No. 247, Germany. The preferred ratio member 12 includes first and second connected pistons 18 and 20 oscillating at the same speeds by pressurizing the first piston 18 in its cylinder with diesel fuel, then pressurizing the second piston 20 in its cylinder with water thereby forcing the diesel fuel from the first piston 18, followed by the pressurizing of the first piston 18 with diesel fuel thereby forcing the water from the second piston 20, then repeating the cycle. The first connected piston 18 is dedicated to taking in and discharging diesel fuel at a first volume, which is primarily dependent upon the required power output from the engine to drive the load placed upon the engine. The diesel fuel is removed from a container 22 by a pump 24, whereupon the diesel fuel is urged through a heat exchanger or temperature reduction member 26, then delivered to the ratio member 12 via fuel lines 52 and 56, and a safety valve 28 that prevents the pump 24 from over pressurizing the ratio member 12. Should the discharge pressure from the pump 24 become to great, the safety valve 28 will remain closed thereby directing all the flowing diesel fuel back into the container 22 via a return line 30 that includes a pressure regulating valve 32.

The second connected piston 20 is dedicated to taking in and discharging water at a second volume, which is relatively smaller than the volume of diesel fuel input into the first piston 18. The water is delivered to the ratio member 12 by a pressurized water container 34. The first and second volumes of diesel fuel and water are maintained at a constant ratio established by programming a microprocessor component (not depicted) of the ratio member 12. The constant ratio of water to diesel fuel is maintained irrespective of the operating parameters of the internal combustion engine. Engine operating parameters include, but are not limited to power demand, exhaust particulate volume, exhaust gas composition, exhaust gas temperature, engine revolutions per minute (“RPM”) and engine temperature.

Alternatively, in the event that greater fuel efficiency was a requirement of the emulsion system 10, electronic signals corresponding to quantities of the above operating parameters of the internal combustion engine could be input into a microprocessor component of a substitute ratio member 12. The microprocessor component would provide an output signal to the substitute ratio member 12 that would adjust the operation of the ratio member 12 to vary the ratio of diesel fuel and water to achieve maximum fuel efficiency and minimum particulate emissions in the exhaust gas from the internal combustion engine. Electronic equipment required to transduce engine operating parameters to electronic signals, and microprocessors that are capable of using the electronic signals to provide corresponding output signals to control or adjust the ratio member are all well known to those of ordinary skill in the art.

The preferred emulsifier 14 for the present invention is also well known to those of ordinary skill in the art, and is manufactured and sold by the inventors from the same address provided above. The emulsifier 14 ultimately mixes, swirls or otherwise combines water and diesel fuel into an emulsion that will be capable of exploding in an internal combustion engine. The diesel fuel-water emulsion must be maintained for substantially about up to two minutes after exiting the emulsifier 14 to insure sufficient time to allow the emulsion to be urged through the fuel injectors 16, combine with air in the cylinders of the engine, then compressed until exploding to generate sufficient output power from the engine.

The emulsifier 14 ultimately emulsifies diesel fuel and water by swirling diesel fuel and water at speeds proximately supersonic, thereby providing an emulsified liquid capable of exploding when mixed with air and subsequently compressed in a cylinder in an internal combustion engine. The emulsified diesel and water forms microscopically small droplets of fuel with a relatively smaller droplet of water inside the diesel fuel droplet. When the diesel fuel droplet and the water fuel droplet therein are injected into a hot diesel engine, the water droplet heats extremely fast and will expand from the heat at a rate that results in the “ripping apart” of the fuel droplet repeatedly, thereby creating smaller droplets in greater numbers. The smaller droplets have correspondingly smaller surface areas, but because there are so many more droplets, the combined surface area all the smaller droplets becomes larger, resulting in more air combining with fuel thereby promoting a faster, cleaner and more efficient combustion process.

The emulsifier 14 is part of an emulsifier loop 36 with emulsifier means therein that include a liquid storage tank 38 having a first input line 40 supplying mixed diesel fuel and water from the ratio member 12, and a second input line 42 supplying either diesel fuel from the diesel fuel container 22 via fuel line 52 or a diesel fuel-water emulsion from the heat exchanger 26 via fuel line 54. The emulsifier means further include an emulsion pump 44 for receiving a water and diesel fuel combination from the liquid storage tank 38, and for ultimately discharging the water and diesel fuel combination at an increased pressure into the emulsifier 14 where the water and diesel fuel are emulsified, then urged from the emulsifier 14 by the emulsion pump 44 to a high pressure injection pump 46. In the event that the emulsion pressure leaving the emulsifier 14 becomes to great, a pressure regulating valve 48 reduces the emulsion pressure by “by-passing” the injection pump 46, thereby reducing the pressure of the emulsion discharged from the injection pump 46. The injection pump 46 urges the emulsified water and diesel fuel through the heat exchanger 26, whereupon a first portion of the emulsified water and diesel fuel is supplied to the fuel injectors 16 of the engine via an injection line 50, and a “non-used” second portion of the emulsified water and diesel fuel is returned to the liquid storage tank 38 via a return line 54 to be ultimately “re-emulsified” due to the relatively short time frame of the emulsified diesel fuel and water to return to a separated state.

The heat exchanger 26 reduces the temperature of the highly heated emulsified diesel fuel and water discharged from the high pressure injection pump 46. The heat exchanger 26 maintains the emulsified water and diesel fuel in a liquid state, thereby promoting an efficient diesel fuel-air mixture after urging the emulsified diesel fuel and water through a fuel injector 16.

When the internal combustion engine is operating at an “idle” RPM rate, the microprocessor of the ratio member 12 “shuts down” the ratio member 12 and a flow control valve 58 opens to allow diesel fuel to flow directly from the diesel fuel container 22 into the liquid storage tank 38, thereby providing only diesel fuel to the internal combustion engine when the engine is in an idle condition. When the engine returns to a predetermined RPM, the flow control valve 58 closes to prevent diesel fuel from flowing from the diesel fuel container 22 to the liquid storage tank 38, thereby supplying only the water-diesel fuel emulsion to the tank 38.

The present invention can be used with any stationary or mobile diesel engine, however, the primary use of this invention is with automobiles and trucks. Further, all the components detailed above are well known to those or ordinary skill in the art, including the materials required to fabricate the components. The entire emulsion system I 0 is manufactured and sold by the above inventors from the provided address. A complete emulsion system 10 is designed for a specified diesel engine, then disposed upon a relatively small board to be installed at a preselected location in the moving vehicle housing the specified diesel engine.

In operation, ratio member 12 is sized and programmed to provide sufficient quantities of emulsified water and diesel fuel at a constant volume ratio of water to a specified diesel fuel (the water volume being set in the range of 0%-25% of the diesel fuel volume). A water tank 34 is added and linked via dedicated plastic or steel line to a water port of the ratio member 12, and an existing diesel fuel supply line that delivers diesel fuel to fuel injectors 16, is rerouted to supply diesel fuel to the ratio member 12 via supply line 56. The ratio member 12 ultimately combines the water and diesel fuel, then urges the combination to a liquid storage tank 38. The supply line 56 connects to a branch line 52 that connects to a return line 30 of the original diesel fuel supply line. The branch line 52 includes a safety valve 28 for preventing excessive line pressures, and a flow control valve 58 that is normally closed but opens to supply diesel fuel to the liquid storage tank 38 via a second input line 42. The flow control valve 58 opens when the diesel engine is at an idle RPM, thereby supplying only diesel fuel to the liquid storage tank 38 and ultimately to the diesel engine until the RPM of the diesel engine increases to a preselected value, whereupon, an electronic controller (not depicted) causes the flow control valve 58 to close. The liquid storage tank 38 ultimately receives the combined water and diesel fuel from the ratio member 12, whereupon, the water and diesel fuel combination is urged via a low pressure pump 44 to an emulsifier 14. The water-diesel fuel combination is emulsified, then urged to a high pressure injection pump 46 via the low pressure pump 44. The injection pump 46 urges the emulsified water and diesel fuel to a heat exchanger 26 where the emulsion is cooled via diesel fuel circulating from the diesel tank 22. The water-diesel emulsion is then urged to a fuel injector supply line 50 that provides the emulsion to the diesel engine's fuel injectors 16, where predetermined quantities of fuel are “sprayed” into the engine's combustion chambers. The excess or unused emulsion fuel from the heat exchanger 26 is recycled back to the liquid storage tank 38 via return line 54 that connects to the second input line 42, which is connected to the liquid storage tank 38. The closed flow control valve 58 prevents the emulsion fuel from “back flowing” to the ratio member 12 or the diesel return line 30.

The foregoing description is for purposes of illustration only and is not intended to limit the scope of protection accorded this invention. The scope of protection is to be measured by the following claims, which should be interpreted as broadly as the inventive contribution permits.

1. An emulsion system for diesel fuel and water for an internal combustion engine comprising:
means for combining diesel fuel and water quantities based upon required power output from an internal combustion engine; and
means for emulsifying diesel fuel and water, whereby diesel fuel and water are combined to provide a fuel for an internal combustion engine that reduces particulate emission from the internal combustion engine and increases the efficiency of the internal combustion engine, while providing sufficient power output from the internal combustion engine to satisfy load demands placed upon the engine.

2. The emulsion system of claim 1 wherein said combining means includes a ratio member.

3. The emulsion system of claim 2 wherein said ratio member includes first and second connected pistons operating at the same speeds, said first connected piston being dedicated for taking in and discharging diesel fuel at a first volume, said second connected piston dedicated for taking in and discharging water at a second volume, said second volume of water being relatively smaller than said first preselected volume of diesel fuel.

4. The emulsion system of claim 2 wherein said ratio member combines diesel fuel and water at a constant ratio irrespective of the operating parameters of the internal combustion engine.

5. The emulsion system of claim 2 wherein said ratio member combines diesel fuel and water at varying ratios depending upon operating parameters of the internal combustion engine.

6. The emulsion system of claim 2 wherein said ratio member combines diesel fuel and water at varying ratios that ultimately achieve minimum particulate emissions in the exhaust gas of the internal combustion engine.

7. The emulsion system of claim 1 wherein said emulsifier means includes means for providing a diesel fuel and water emulsion that will be capable of exploding in an internal combustion engine for substantially about up to two minutes after exiting the emulsifier.

8. The emulsion system of claim 1 wherein said emulsifier means includes means for swirling diesel fuel and water at speeds proximately super sonic, thereby providing a diesel fuel and water emulsion capable of exploding in an internal combustion engine such that required power is generated and particulate emission is reduced.

9. The emulsion system of claim 1 wherein said emulsifier means comprises:
a liquid storage tank having a first input line supplying diesel fuel and water from said combining means, and a second input line supplying diesel fuel from a diesel fuel container, said liquid storage tank having an output line supplying an emulsifier;
an emulsion pump for receiving a water and diesel fuel combination from said liquid storage tank, and for ultimately discharging said water and diesel fuel combination at an increased pressure;
an emulsifier for receiving said water and diesel fuel combination from said emulsion pump, said emulsifier ultimately emulsifying said water and diesel fuel combination such that said combination will ultimately explode in an internal combustion engine when mixed with air and then compressed; and
an injection pump for urging said emulsified water and diesel fuel combination through a heat exchanger, whereupon a first portion of said emulsified water and diesel fuel combination is supplied to an internal combustion engine, and a second portion is returned to said liquid storage tank.

10. A method for reducing particulate emissions from an internal combustion engine, said method comprising the steps of:
combining diesel fuel and water at predetermined quantities corresponding to required power output from an internal combustion engine; and
emulsifying said combined diesel fuel and water quantities, whereby particulate emission from the internal combustion engine is reduced, while providing required power output and increasing fuel efficiency.

11. The method of claim 10 wherein the step of combining diesel fuel and water includes the step of providing a ratio member.

12. The method of claim 10 wherein the step of combining diesel fuel and water includes the step of combining diesel fuel and water at a fixed ratio irrespective of internal combustion engine operating parameters.

13. The method of claim 10 wherein the step of combining diesel fuel and water includes the step of combining diesel fuel and water at selected ratios to achieve maximum engine fuel efficiency and minimum particulate emissions in the exhaust gas from the engine.

14. The method of claim 10 wherein the step of emulsifying diesel fuel and water includes the step of maintaining said emulsified diesel fuel and water for substantially about two minutes, thereby providing sufficient time for said emulsified diesel fuel and water to be supplied to fuel injectors and ultimately injected into cylinders in the internal combustion engine and ultimately exploded to generate sufficient output power.

15. The method of claim 10 wherein the step of emulsifying diesel fuel and water includes the step of providing an emulsifier capable of swirling diesel fuel and water at speeds proximately super sonic, thereby providing an emulsified liquid capable of exploding when mixed with air and subsequently compressed in a cylinder in an internal combustion engine.

16. The method of claim 10 wherein the step of emulsifying diesel fuel and water includes the step of pumping said emulsified diesel fuel and water through a temperature reduction member, thereby maintaining said emulsified diesel fuel and water in a liquid state and promoting an efficient fuel-air mixture after urging said emulsified diesel fuel and water through a fuel injector.

17. A device for increasing fuel efficiency in an internal combustion engine comprising:
a ratio member for combining predetermined quantities of diesel fuel and water;
an emulsifier for emulsifying diesel fuel and water such that the resulting combination is ultimately exploded in an internal combustion engine; and
means for providing only diesel fuel to the internal combustion engine when the internal combustion engine is in an idle condition.

18. The device of claim 17 wherein said ratio member maintains a constant diesel fuel-water ratio that satisfies power output requirements imposed upon the internal combustion engine irrespective of changing operating parameters imposed upon the internal combustion engine.

19. The device of claim 17 wherein said ratio member varies said diesel fuel-water ratio to maximize fuel efficiency when changing operating parameters are imposed upon the internal combustion engine, said ratio member concurrently satisfying power output requirements imposed upon the internal combustion engine.

20. The device of claim 17 wherein said diesel fuel providing means includes a flow control valve that opens to allow diesel fuel to flow from a diesel fuel storage tank to a liquid storage tank until the internal combustion engine attains a predetermined RPM, whereupon, said flow control valve closes to prevent diesel fuel from flowing from said diesel fuel container to said liquid storage tank.
